(19) United States
(12) Patent Application Publication
(10) Pub. No.: US 2012/0308899 A1
(43) Pub. Date: Dec. 6, 2012

(54) Polymer-Based Solid Electrolytes and Preparation Methods Thereof

(75) Inventors: Chung-Bo Tsai, New Taipei City (TW); Yan-Ru Chen, New Taipei City (TW); Wen-Hsien Ho, New Taipei City (TW); Kuo-Feng Chiu, New Taipei City (TW); Shih-Hsuan Su, New Taipei City (TW)

(73) Assignee: TAIWAN TEXTILE RESEARCH INSTITUTE, New Taipei City (TW)

(21) Appl. No.: 13/572,728

(22) Filed: Aug. 13, 2012

Related U.S. Application Data
(63) Continuation-in-part of application No. 13/397,883, filed on Feb. 16, 2012.

(30) Foreign Application Priority Data
Feb. 16, 2011 (TW) 100105123

(51) Int. Cl. H01M 10/056

(52) U.S. Cl. 429/307; 429/306; 429/314; 429/317

(57) ABSTRACT

SPEEK solid electrolytes and preparation methods thereof are provided. The SPEEK solid electrolyte comprises sulfonated polyetheretherketone (SPEEK), an electrolyte, and a solvent. The electrolyte is a lithium salt.

### CROSS-REFERENCE TO RELATED APPLICATION

The present application is a continuation-in-part application of U.S. application Ser. No. 13/397,883, filed Feb. 16, 2012, which claims priority to Taiwanese Application Serial Number 100105123, filed Feb. 16, 2011. The entire disclosures of all the above applications are hereby incorporated by reference herein.

### BACKGROUND

1. Technical Field

The disclosure relates to an electrolyte and a preparation method thereof. More particularly, the disclosure relates to a solid electrolyte and a preparation method thereof.

2. Description of Related Art

Lithium secondary (rechargeable) batteries (abbreviated as lithium batteries below) have advantages of high working potential, high energy potential, light weight, and long life. Therefore, the lithium batteries have been widely applied on consumer electronics products and some high power products.

The electrolyte used in the lithium batteries can be divided into liquid electrolyte and solid electrolyte. Although the liquid electrolyte has higher ionic conductivity, the electrolyte is easily leaked, and thus a more complicated package is needed. Therefore, it is difficult to reduce the size of the lithium batteries using liquid electrolyte.

Comparing with the liquid electrolyte, the lithium batteries using solid electrolyte (also called as solid thin film batteries) do not need to worry about the leakage problem, and thus have higher safety. Furthermore, since the thickness of the solid thin film batteries is only 1-20 μm, the solid thin film batteries can be made into any sizes and shapes to meet various requirements. Moreover, the solid thin film batteries have high power density, can be charged and discharged for thousands times and in a high-temperature environment. Since the solid thin film batteries have the features above, the solid thin film batteries have been applied in products, such as IC card, flexible electronic devices, and biomedical applications; those need thin flexible power supply.

In the research of the solid electrolyte, the main goals still include increasing the energy density, the number of charge and discharge cycles, the mechanical strength, reliability, the thermal stability of the solid thin film batteries.

### SUMMARY

Accordingly, one aspect of this invention is to provide a polymer-based solid electrolyte that has a small thermal change rate of conductivity and capacitance to provide a stable conductivity and capacitance over a wide temperature range.

Accordingly, a SPEEK solid electrolyte is provided. The SPEEK solid electrolyte comprises a lithium salt, sulfonated polyetheretherketone (SPEEK), and a polar aprotic solvent.

According to an embodiment, the lithium salt can be LiClO₄, LiBF₄, LiPF₆, LiAsF₆, LiCF₃SO₃, LiN(CF₃SO₃)₂, LiBr, or any combinations thereof.

According to another embodiment, the SPEEK has a molecular weight of about 10,000-50,000 Da.

According to yet another embodiment, the polar aprotic solvent comprises dimethyl sulfoxide, N-methyl pyrrolidinone, dimethylformamide, dimethylacetamide, or any combinations thereof.

According to yet another embodiment, a weight ratio of the lithium salt to the SPEEK is at most 2.

According to yet another embodiment, the polar aprotic solvent comprises dimethyl sulfoxide, N-methyl pyrrolidinone, Dimethylformamide, Dimethylacetamide, or any combinations thereof.

According to yet another embodiment, the content of the polar aprotic solvent is at most 40 wt %.

According to yet another embodiment, the SPEEK solid electrolyte further comprises a lithium salt solution, which adsorbs on or enters into the SPEEK solid electrolyte by immersing the SPEEK solid electrolyte in the lithium salt solution.

According to yet another embodiment, the lithium salt of the lithium salt solution above is LiOH, LiNO₃, Li₂SO₄, LiClO₄, LiCF₃SO₃, LiN(CF₃SO₃)₂, or any combinations thereof.

According to yet another embodiment, the solvent of the lithium salt solution is ethylene carbonate, ethyl methyl carbonate, dimethyl carbonate, or propylene carbonate.

In another aspect, this invention also provides a method of preparing the various SPEEK solid electrolytes above.

In this preparation method, a SPEEK solution is prepared by dissolving sulfonated polyetheretherketone (SPEEK) in a polar aprotic solvent. Then, a lithium salt is dissolved in the SPEEK solution to form a SPEEK electrolyte solution. Next, the SPEEK electrolyte solution is coated on a substrate and then dried to form a SPEEK solid electrolyte layer on the substrate.

According to an embodiment, the SPEEK electrolyte solution is dried at a temperature of about 60-120° C. for at most 72 hours.

According to another embodiment, the SPEEK solid electrolyte layer can further immersed in the lithium salt solution above for about 1-60 sec after the drying step to reduce the charge transfer resistance between the solid electrolyte and a contacting electrode, but also increase the mobility of ions in solid electrolyte.

The foregoing presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

Many of the attendant features will be more readily appreciated as the same becomes better understood by reference to the following detailed description considered in connection with the accompanying drawings.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### SPEEK Solid Electrolyte

In one aspect, this invention provides a polymer-based solid electrolyte that has a small thermal change rate of conductivity and capacitance to provide a stable conductivity and capacitance over a wide temperature range. Accordingly, a SPEEK solid electrolyte having a small thermal change rate of conductivity and capacitance over a temperature range of 25-80° C. is provided below. The thermal change rate of the conductivity can be smaller than 80%, and the thermal change rate of the capacitance can be smaller than 110%. The SPEEK solid electrolyte comprises a lithium salt, sulfonated polyetheretherketone (SPEEK), and a polar aprotic solvent.

According to an embodiment, the lithium salt above can be a lithium salt with lower lattice energy, such as LiClO₄, LiBF₄, LiPF₆, LiAsF₆, LiCF₃SO₃, LiN(CF₃SO₃)₂, LiBr, or any combinations thereof. A lithium salt with lower lattice energy can increase the ionic conductivity of the SPEEK solid electrolyte. Furthermore, the concentration of the lithium salt in the SPEEK solid electrolyte is better to be at most 9.4 mmol/g, such as 1.6-4.7 mmol/g. Generally, the ionic conductivity of the SPEEK solid electrolyte is higher when the lithium salt's content is higher. However, if the lithium salt's content is too high, white turbidities will occur in the SPEEK solid electrolyte, and a film of the SPEEK solid electrolyte can be uneven. This may be caused by destroying the SPEEK's crystallinity by the over high lithium salt's content therein.

According to another embodiment of this invention, the SPEEK's molecular weight is better to be 10,000-50,000 Da, such as 20,000-30,000 Da. Since SPEEK is a polymeric material, the above SPEEK's molecular weight can affect the formation condition, such as drying temperature and drying time, and the mechanical strength, such as tensile strength, of the SPEEK solid electrolyte.

According to yet another embodiment, the content of the polar aprotic solvent is less than 40 wt %. The polar aprotic solvent can be dimethyl sulfoxide (DMSO), N-methyl pyrrolidinone (NMP), dimethylformamide (DMF), dimethylacetamide (DMAc), or any combinations thereof.

### Preparation of SPEEK Solid Electrolyte

The SPEEK solid electrolyte above can be prepared by the following steps. First, SPEEK can be prepared by sulfonating polyetheretherketone (PEEK). The sulfonating agent of the sulfonating reaction above can be sulfuric acid, for example. The sulfonating condition of the sulfonating reaction above can be performed at about 50° C. for about 12 hours, for example. An exemplary chemical structure of the obtained SPEEK is shown below.

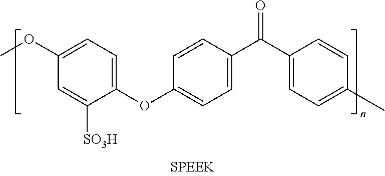

Then, a SPEEK solution is prepared by dissolving sulfonated polyetheretherketone (SPEEK) in a polar aprotic solvent. According to an embodiment, the SPEEK solution contains 1-12 wt % of SPEEK. The polar aprotic solvent can be DMSO dimethyl sulfoxide (DMSO), N-methyl pyrrolidinone (NMP), dimethylformamide (DMF), dimethylacetamide (DMAc), or any combinations thereof, for example.

According to another embodiment, the SPEEK solution can be further optionally heated to increase the dissolving rate or the SPEEK in the polar aprotic solvent. For example, if the weight of the SPEEK solution is about 105 g (5 g SPEEK+100 g DMSO), the SPEEK solution can be heated at about 60° C. for about 2-4 hours to substantially dissolve the SPEEK therein.

Next, a lithium salt is dissolved in the SPEEK solution to form a SPEEK electrolyte solution. The added amount of the lithium salt can be at most 2 times of the added SPEEK's weight.

According to an embodiment, the lithium salt can be directly added into the SPEEK solution to directly dissolve the lithium salt therein to form the SPEEK electrolyte solution. During this step, the solution can be further stirred, heated, or stirred and heated, to uniformly mix each component in the SPEEK electrolyte solution. The heating temperature can be about 60° C. to 70% of the polar aprotic solvent's boiling point. If the heating temperature is too low, the solubility of the SPEEK in the polar aprotic solvent will be too low, and the viscosity of the SPEEK electrolyte solution will be too high to facilitate the subsequent coating step.

If the SPEEK electrolyte solution is prepared by a method including stirring, bubbles may be produced in the SPEEK electrolyte solution. Since the bubbles will affect the quality of the SPEEK solid electrolyte, the SPEEK electrolyte solution is better to stay for a period of time, such as 5-10 minutes, to remove the bubbles therein.

Next, the SPEEK electrolyte solution is coated on a substrate and subsequently dried to form a SPEEK solid electrolyte layer on the substrate. The substrate above can be a rigid substrate, such as a stainless steel substrate, or a flexible substrate, such as a textile.

The drying temperature and time is usually determined by the solvent used for the SPEEK electrolyte solution and the needed solvent content of the finally obtained SPEEK solid electrolyte layer. Furthermore, the drying temperature and time can affect the mechanical strength and the ionic conductivity. Accordingly, the drying temperature above can be about 60-120° C., such as 60, 65, 70, 75, 80, 85, 90, 95, 100, 105, 110, 115, or 120° C. The drying time can be at most 72 hours.

Finally, the dried SPEEK solid electrolyte layer on the substrate can be further optionally immersed in a lithium salt solution for about 1-60 sec after the drying step to reduce the charge transfer resistance between the solid electrolyte and a contacting electrode, but also increase the mobility of ions in solid electrolyte. Then, the conductivity of the interface between the SPEEK solid electrolyte layer and an electrode can be further improved.

The lithium salt used in the lithium salt solution can be LiOH, LiNO₃, Li₂SO₄, LiClO₄, LiCF₃SO₃, LiN(CF₃SO₃)₂, or a combination thereof. The concentration of the lithium salt in the liquid solution is better to be at most 10 M.

The solvent used in the lithium salt solution can be water, ethylene carbonate (EC), ethyl methyl carbonate (EMC), dimethyl carbonate (DMC), or propylene carbonate (PC).

### Preparation of Flexible Lithium Batteries

### Using SPEEK Solid Electrolyte

In another aspect, a preparation method of flexible lithium batteries is provided. This preparation method of the flexible lithium batteries basically utilizes the preparation method of the SPEEK solid electrolyte to increase the related efficacy of the flexible lithium batteries.

After the preparation steps of the SPEEK electrolyte solution above, the SPEEK electrolyte solution can be respectively coated on both opposite surfaces of a flexible substrate. The coating method can be spray coating, knife coating, roller coating, spinning coating, dip coating, or curtain coating. Next, the SPEEK coated flexible substrates are dried at a temperature of 60-120° C. for at most 72 hours to obtain SPEEK solid electrolyte films.

The flexible substrate above can be a textile, such as a textile made of glass fibers to increase the mechanical strength of the composite structure of the flexible substrate uniformly coated by SPEEK solid electrolyte, and thus the finally obtained flexible lithium batteries.

Next, a positive electrode layer and a negative electrode layer are respectively formed on the two opposite outer surfaces of the composite structure of the flexible substrate uniformly coated by SPEEK solid electrolyte to obtain the flexible lithium battery. For example, the flexible lithium battery can be assembled by the following method, but this invention is not limited thereto.

In this method, a positive and a negative electrode layers can be independently formed by using suitable material. Then, the composite structure of the flexible substrate embedded in the SPEEK solid electrolyte film is sandwiched by the positive and the negative electrode layers. A thermopressing step is performed to combine each material layer to obtain a flexible lithium battery. During the thermopressing step, the solvent content of the SPEEK solid electrolyte layers will be further reduced by evaporating.

Moreover, the SPEEK solid electrolyte can be further used to prepare flexible capacitors. For example, a textile can also be used as the flexible substrate to obtain a composite structure of the flexible substrate embedded in the SPEEK solid electrolyte film. Then, the composite structure above can be used to form a textile capacitor.

For better understanding the preparation method and the properties of the SPPEK-based solid electrolyte, some experimental results are provided below.

### Experiment 1

### Effect of Various Lithium Salts to Resistance

In this experiment, a SPEEK solution was prepared by adding 5 g of SPEEK into 100 g of DMSO, and then stirred at 60° C. to dissolve the SPEEK in the DMSO. Next, various lithium salts were respectively added into the SPEEK solution to form various SPEEK electrolyte solutions with various lithium salts. Each of the SPEEK electrolyte solutions was then coated on a substrate and then dried at 60° C. to form SPEEK solid electrolyte on the substrate. Finally, the SPEEK solid electrolyte on the substrate was immersed in water for 10 sec. The conditions and results are listed in Table 1.

TABLE 1
Effect of Various Lithium Salts to Resistance

| Samples | Lithium salt | Resistance (Ω) |
|---|---|---|
| 1-1 | — | 1.739 |
| 1-2 | LiClO₄ | 1.537 |
| 1-3 | LiCF₃SO₃ | 1.087 |
| 1-4 | LiN(CF₃SO₃)₂ | 0.874 |

From the result of the Table 1, it can be known that resistance of the SPEEK solid electrolyte containing LiN(CF₃SO₃)₂ is the smallest. It showed that the transportation of LiN(CF₃SO₃)₂ in the SPEEK solid electrolyte was the easiest.

### Experiment 2

### Effect of Lithium Salt Concentration to Ionic Conductivity

In this experiment, a SPEEK solution was prepared by adding 5 g of SPEEK into 100 g of DMSO, and then stirred at 60° C. to dissolve the SPEEK in the DMSO. Next, various amounts of LiClO₄ was added into the SPEEK solution to form SPEEK electrolyte solutions with various lithium salt concentration. Each of the SPEEK electrolyte solutions was then coated on a substrate and then dried at 60° C. to form SPEEK solid electrolyte on the substrate. Finally, the SPEEK solid electrolyte on the substrate was immersed in water for 10 sec. The conditions and results are listed in Table 2.

TABLE 2
Effect of Lithium Salt Concentration to Ionic Conductivity

| | Concentration of LiClO₄ | Ionic Conductivity* |
|---|---|---|
| Sample | (mmol/g) | (S/cm) |
| 5-1 | 0 | 6.21 × 10⁻³ |
| 5-2 | 1.6 | 9.40 × 10⁻³ |
| 5-3 | 2.7 | 12.63 × 10⁻³ |
| 5-4 | 3.5 | 16.04 × 10⁻³ |

*Ionic Conductivity = thickness/(resistance × surface area), wherein resistance was measured by AC impedance analyzer including Potentiostat/Galvanostat (Model 263 A) and Frequency Response Detector (Model FRD100) purchased from Princeton Applied Research.

From the results of Table 2, it can be known that the ionic conductivity was increased with the increase of the lithium salt content.

### Experiment 3

### Thermal Change Rate of Conductivity and Capacitance of LiClO₄-SPEEK Solid Electrolyte

In Examples 3-1 to 3-3 of this experiment, a SPEEK solution was prepared by adding 5 g of SPEEK into 100 g of DMSO, and then stirred at 60° C. to dissolve the SPEEK in the DMSO. Next, LiClO₄ was added into the SPEEK solution to form SPEEK electrolyte solutions. Each of the SPEEK electrolyte solutions was then coated on a substrate and then dried at 60° C. to form SPEEK solid electrolyte on the substrate. The concentration of the LiClO₄ in the SPEEK solid electrolyte is 4.7 mmol/g. Next, each of the SPEEK solid electrolytes was immersed in various immersing liquids for about 10 seconds, and then respectively measured the conductivity and the capacitance at 25° C. and 80° C.

In Comparative Examples 3-1 and 3-2, poly vinyl alcohol (PVA) and polyethylene oxide (PEO) were used to replace SPEEK to prepare PVA solid electrolyte and PEO solid electrolyte. The concentration of the LiClO₄ in the PVA solid electrolyte was 3.2 mmol/g. The concentration of the LiClO₄ in the PEO solid electrolyte was unknown, since Choi's paper did not disclose it. The conductivity and the capacitance of the Comparative Examples were respectively measured at 25° C. and 80° C.

The preparation conditions and results are listed in Table 3.

TABLE 3
Thermal Change Rate of Conductivity and Capacitance of
LiClO₄-SPEEK solid electrolyte

| | Polymer-Based | | Thermal Change Rate (%) | |
|---|---|---|---|---|
| | Solid | Immersing | over 25-80° C. | |
| | Electrolyte | Liquid | ¹Conductivity | ²Capacitance |
| Example 3-1 | SPEEK-LiClO₄ | Water | 77.9 | 38.7 |
| Example 3-2 | | 3M | 27.2 | 55.3 |
| | | LiON_{(aq)} | | |
| Example 3-3 | | 3M | 15.0 | 16.4 |
| | | LiNO_{3(aq)} | | |
| Comparative | PVA-LiClO₄ | Water | 429.5 | 334.1 |
| Example 3-1 | | | | |
| Comparative | ³PEO-LiClO₄ | — | 32,400 | — |
| Example 3-2 | | | | |

¹Calculated by (σ_{80° C.} − σ_{25° C.})/σ_{25° C.} × 100
²Calculated by (C_{80° C.} − C_{25° C.})/C_{25° C.} × 100
³From FIG. 2 of Materials Science and Engineering, B107 (2004), pp 244-250.

From the results of Table 3, it can be known that the thermal change rate of the conductivity and capacitance for the SPEEK solid electrolytes is the smallest among the three different kinds of polymers (SPEEK, PVA, and PEO). In Examples 6-1 to 6-3, the various immersing liquids also affect the thermal change rate of the conductivity and capacitance. The most amazing one is SPEEK-LiClO₄ immersed in LiNO_{3(aq)}, which has only a thermal change rate of 15.0% for conductivity and 16.4% for capacitance.

### Experiment 4

### Thermal Change Rate of Conductivity and Capacitance of LiCF₃SO₃-SPEEK Solid Electrolyte

In Examples 4-1 to 4-3, a SPEEK solution was prepared by adding 5 g of SPEEK into 100 g of DMSO, and then stirred at 60° C. to dissolve the SPEEK in the DMSO. Next, LiCF₃SO₃ was added into the SPEEK solution to form SPEEK electrolyte solutions. Each of the SPEEK electrolyte solutions was then coated on a substrate and then dried at 60° C. to form SPEEK solid electrolyte on the substrate. The concentration of the LiCF₃SO₃ in the SPEEK solid electrolyte was 3.2 mmol/g. Next, each of the SPEEK solid electrolytes was immersed in various immersing liquids for about 10 seconds, and then respectively measured the conductivity and the capacitance at 25° C. and 80° C. The preparation conditions and results are listed in Table 4.

TABLE 4
Thermal Change Rate of Conductivity and Capacitance of
LiCF₃SO₃-SPEEK solid electrolyte

Thermal Change Rate (%)
over 25-80° C.

| Examples | Immersing Liquid | ¹Conductivity | ²Capacitance |
|---|---|---|---|
| 4-1 | Water | 101.3 | 341.6 |
| 4-2 | 3M LiOH_{(aq)} | 55.7 | 107.1 |
| 4-3 | 3M LiNO_{3(aq)} | 2.0 | 39.2 |

¹Calculated by (σ_{80° C.} − σ_{25° C.})/σ_{25° C.} × 100
²Calculated by (C_{80° C.} − C_{25° C.})/C_{25° C.} × 100

From the results of Table 4, it can be known that the SPEEK solid electrolyte having the smallest thermal change rate was still the one (Sample 4.3) immersed in LiNO₃ solution after the lithium salt in SPEEK solid electrolyte was changed from LiClO₄ to LiCF₃SO₃.

The inventors discovered that the LiCF₃SO₃-SPEEK solid electrolyte would undergo oxidation reaction when the operation voltage greater than 0.5 V, and the capacitance calculated from cyclic voltammetry curve was thus increased. This may be the reason why the thermal change rate is so great for the LiCF₃SO₃-SPEEK solid electrolyte of Sample 4-1 immersed in water. However, LiCF₃SO₃-SPEEK solid electrolytes of Samples 4-2 and 4-3 immersed in lithium solution can effectively inhibit the oxidation reaction to decrease the thermal change rate of conductivity and capacitance of the LiCF₃SO₃-SPEEK solid electrolytes to increase the thermal stability thereof.

### Experiment 5

### Thermal Change Rate of Conductivity and Capacitance of LiN(CF₃SO₃)₂-SPEEK Solid Electrolyte

In Examples 5-1 to 5-3, a SPEEK solution was prepared by adding 5 g of SPEEK into 100 g of DMSO, and then stirred at 60° C. to dissolve the SPEEK in the DMSO. Next, LiN(CF₃SO₃)₂ was added into the SPEEK solution to form SPEEK electrolyte solutions. Each of the SPEEK electrolyte solutions was then coated on a substrate and then dried at 60° C. to form SPEEK solid electrolyte on the substrate. The concentration of the LiN(CF₃SO₃)₂ in the SPEEK solid electrolyte was 1.6 mmol/g. Next, each of the SPEEK solid electrolytes was immersed in various immersing liquids for about 10 seconds, and then respectively measured the conductivity and the capacitance at 25° C. and 80° C. The preparation conditions and results are listed in Table 5.

TABLE 5
Thermal Change Rate of Conductivity and Capacitance of
LiN(CF₃SO₃)₂-SPEEK solid electrolyte

Thermal Change
Rate (%) over 25-80° C.

| Examples | Immersing Liquid | ¹Conductivity | ²Capacitance |
|---|---|---|---|
| 5-1 | Water | 94.7 | 755.7 |
| 5-2 | 3M LiOH_{(aq)} | 13.6 | 57.9 |
| 5-3 | 3M LiNO_{3(aq)} | 26.6 | 57.3 |

¹Calculated by (σ_{80° C.} − σ_{25° C.})/σ_{25° C.} × 100
²Calculated by (C_{80° C.} − C_{25° C.})/C_{25° C.} × 100

From the results of Table 5, it can be known that the thermal change rate of conductivity and capacitance of the SPEEK solid electrolyte were similar for the Samples 5-2 and 5-3 immersed in LiNO₃ and LiOH solution, after the lithium salt in SPEEK solid electrolyte was changed from LiClO₄ to LiN(CF₃SO₃)₂. SPEEK solid electrolyte immersed in LiOH solution (Sample 5-2) was still better.

The inventors discovered that the LiN(CF₃SO₃)₂-SPEEK solid electrolyte would undergo oxidation reaction when the operation voltage greater than 0.5 V, and the capacitance calculated from cyclic voltammetry curve was thus increased. This may be the reason why the thermal change rate is so great for the LiN(CF₃SO₃)₂-SPEEK solid electrolyte of Sample 5-1 immersed in water. However, LiN(CF₃SO₃)₂-SPEEK solid electrolytes of Samples 5-2 and 5-3 immersed in lithium solution can effectively inhibit the oxidation reaction to decrease the thermal change rate of conductivity and capacitance of the LiN(CF₃SO₃)₂-SPEEK solid electrolytes to increase the thermal stability thereof.

### Experiment 6

### Thermal Change Rate of Conductivity of SPEEK Solid Electrolytes

The preparation methods for each sample of SPEEK solid electrolytes containing lithium salts have been described above, and thus omitted here. The preparation method for sample of SPEEK solid electrolyte without containing lithium salts was basically the same as those preparation methods for PEEK solid electrolytes containing lithium salts, except the lithium salt adding step was omitted. The results are listed in Table 6 below.

TABLE 6
Thermal Change Rate of Conductivity* of SPEEK solid
electrolytes

| | |
|---|---|
| Lithium salt of SPEEK | Immersing Liquid |

| solid electrolyte | 3M LiOH_{(aq)} | 3M LiNO_{3(aq)} |
|---|---|---|
| — | −59.2 | 170.5 |
| LiClO₄ | 27.2 | 15.0 |
| LiCF₃SO₃ | 55.7 | 2.0 |
| LiN(CF₃SO₃)₂ | 13.6 | 26.6 |

*Calculated by (σ_{80° C.} − σ_{25° C.})/σ_{25° C.} × 100

From the results of Table 6, it can be known that there were two factors could affect the thermal change rate of the conductivity and capacitance. One was the kinds of the lithium salt in the immersing liquid, and the other was the kinds of the lithium salt in the SPEEK solid electrolyte. In Table 6, the thermal change rate of the conductivity of the SPEEK solid electrolyte without adding lithium salt was the largest, and it shows that the thermal stability of the SPEEK solid electrolyte without adding lithium salt was poor. Among SPEEK solid electrolytes containing lithium salts, the LiCF₃SO₃-SPEEK solid electrolyte immersed in LiNO₃ solution had the smallest thermal change rate, only 2%, very surprisingly. The thermal change rate of conductivity of the other SPEEK solid electrolytes containing lithium salts were all below 56%.

In light of foregoing, the SPEEK solid electrolyte containing lithium salts can have excellent thermal stability. This result shows that SPEEK solid electrolytes are very suitable to be used in various electronic products requiring to be operated under high temperature. For example, lithium batteries and flexible supercapacitors containing the SPEEK solid electrolytes above can be used in the electronic products of cars.

All the features disclosed in this specification (including any accompanying claims, abstract, and drawings) may be replaced by alternative features serving the same, equivalent or similar purpose, unless expressly stated otherwise. Thus, each feature disclosed is one example only of a generic series of equivalent or similar features.

What is claimed is:

1. A SPEEK solid electrolyte having conductivity's thermal change rate smaller than 80% and capacitance's thermal change rate smaller than 110%, the SPEEK solid electrolyte comprising:
sulfonated polyetheretherketone (SPEEK);
a first lithium salt distributed in the SPEEK, wherein a concentration of the first lithium salt is at most 9.4 mmol/g; and
a polar aprotic solvent, wherein a content of the solvent is less than 40 wt %.

2. The SPEEK solid electrolyte of claim 1, wherein a molecular weight of the SPEEK is 10,000-50,000 Da.

3. The SPEEK solid electrolyte of claim 1, wherein the first lithium salt is LiClO₄, LiBF₄, LiPF₆, LiAsF₆, LiCF₃SO₃, LiN(CF₃SO₃)₂, LiBr, or any combinations thereof.

4. The SPEEK solid electrolyte of claim 1, wherein the polar aprotic solvent comprises dimethyl sulfoxide, N-methyl pyrrolidinone, Dimethylformamide, Dimethylacetamide, or any combinations thereof.

5. The SPEEK solid electrolyte of claim 1, further comprising a lithium salt solution, which adsorbs on or enters into the SPEEK solid electrolyte by immersing the SPEEK solid electrolyte in the lithium salt solution.

6. The SPEEK solid electrolyte of claim 5, wherein a second lithium salt of the lithium salt solution is LiOH, LiNO₃, Li₂SO₄, LiClO₄, LiCF₃SO₃, LiN(CF₃SO₃)₂, or any combinations thereof.

7. The SPEEK solid electrolyte of claim 5, wherein a solvent of the lithium salt solution is ethylene carbonate, ethyl methyl carbonate, dimethyl carbonate, or propylene carbonate.

8. A flexible lithium battery, comprising:
a substrate;
two SPEEK-solid electrolyte layers on opposite surfaces of the substrate, composition of the two SPEEK-solid electrolyte layers comprising:
sulfonated polyetheretherketone (SPEEK);
a first lithium salt distributed in the SPEEK, and a content of the first lithium salt to the SPEEK being at most 9.4 mmol/g; and
a polar aprotic solvent, wherein a content of the solvent is less than 40 wt %; and
two electrode layers on two exposed surfaces of the two SPEEK-solid electrolyte layers.

9. A preparation method of a SPEEK solid electrolyte, comprising:
preparing a sulfonated polyetheretherketone (SPEEK) solution by dissolving SPEEK in a polar aprotic solvent;
dissolving a first lithium salt in the SPEEK solution to form a SPEEK electrolyte solution;
coating the SPEEK electrolyte solution on a substrate; and
drying the SPEEK electrolyte solution to form a SPEEK solid electrolyte layer on the substrate.

10. The preparation method of claim 9, wherein a molecular weight of the SPEEK is 10,000-50,000 Da.

11. The preparation method of claim 9, wherein the polar aprotic solvent comprises dimethyl sulfoxide, N-methyl pyrrolidinone, dimethylformamide, dimethylacetamide, or any combinations thereof.

12. The preparation method of claim 9, wherein the first lithium salt is LiClO₄, LiBF₄, LiPF₆, LiAsF₆, LiCF₃SO₃, LiN(CF₃SO₃)₂, LiBr, or any combinations thereof.

13. The preparation method of claim 9, wherein a weight ratio of the first lithium salt to the SPEEK is at most 2 in the SPEEK electrolyte solution.

14. The preparation method of claim 9, wherein the SPEEK electrolyte solution is dried at a temperature of about 60-120° C. for at most 72 hours.

15. The preparation method of claim 9, wherein a solvent content of the SPEEK solid electrolyte is smaller than 40 wt %.

16. The preparation method of claim 9, further comprising immersing the SPEEK solid electrolyte layer in a lithium salt solution for about 1-60 sec after the drying step.

17. The preparation method of claim 16, wherein a second lithium salt of the lithium salt solution is LiOH LiNO₃, Li₂SO₄, LiClO₄, LiCF₃SO₃, or LiN(CF₃SO₃)₂, or any combinations thereof.

18. The preparation method of claim 16, wherein the concentration of the second lithium salt in the lithium salt solution is at most 10 M.

19. The preparation method of claim 16, wherein a solvent of the lithium salt solution is ethylene carbonate, ethyl methyl carbonate, dimethyl carbonate, or propylene carbonate.

20. The preparation method of claim 9, further comprising forming two electrode layers respectively on opposite outer surfaces of the SPEEK solid electrolyte layer on the substrate.
